(19) United States
(12) Patent Application Publication
(10) Pub. No.: US 2017/0115532 A1
(43) Pub. Date: Apr. 27, 2017

(54) DISPLAY PANEL, PHOTO-ALIGNMENT FILM AND FABRICATION METHOD THEREOF

(71) Applicants: Xiamen Tianma Micro-electronics Co., Ltd., Xiamen (CN); Tianma Micro-electronics Co., Ltd., Shenzhen (CN)

(72) Inventors: Jieliang LI, Xiamen (CN); Yong YUAN, Shanghai (CN); Qi TANG, Xiamen (CN)

(21) Appl. No.: 15/398,328

(22) Filed: Jan. 4, 2017

(30) Foreign Application Priority Data
Jul. 29, 2016 (CN) 2016-10614913.1

(51) Int. Cl. G02F 1/1337; G02F 1/1362; G02F 1/1335; G02F 1/1368; G02F 1/1343

(52) U.S. Cl. CPC G02F 1/133788; G02F 1/1368; G02F 1/134309; G02F 1/133514; G02F 1/136204; G02F 1/136286; G02F 1/133723; G02F 2201/123; G02F 2201/121; G02F 2201/503; G02F 2001/133796; G02F 2202/104

(57) ABSTRACT

A display panel, a photo-alignment film, and a fabrication method of the photo-alignment film are provided. The display panel includes a first substrate, a second substrate disposed opposite to the first substrate, and a liquid crystal layer sandwiched between the first substrate and the second substrate. The first substrate includes a first photo-alignment film comprising a first photo-alignment layer and a first conductive layer that are stacked. The first photo-alignment layer is disposed close to the liquid crystal layer, and the first conductive layer is electrically connected to a conductive structure in the display panel. A resistivity of the first conductive layer is smaller than 10¹⁴ Ω·cm. The second substrate includes a second photo-alignment film disposed close to the liquid crystal layer.

### CROSS-REFERENCES TO RELATED APPLICATIONS

This application claims priority of Chinese Patent Application No. 201610614913.1, filed on Jul. 29, 2016, the entire contents of which are hereby incorporated by reference.

### BACKGROUND

When producing liquid crystal display panels, the technique applied to align liquid crystal molecules is of vital importance. Currently, the most widely applied alignment technology in manufacturing liquid crystal display panels is a rubbing alignment process, which endows the liquid crystal molecules with a relatively strong alignment ability. However, during the process of rubbing, static electricity and particulate pollution often occur when alignment layers directly contact the rubbing cloth, not only resulting in damages of liquid crystal elements, but also causing various issues regarding the image quality.

To improve the image quality and the yield of liquid crystal display panels, many manufacturers seek to apply the photo-alignment technology to align the liquid crystal. However, due to the fact that photo-alignment materials in the photo-alignment technology used for alignment may contain molecules having an alignment function, it is often difficult to fabricate photo-alignment films into low-resistance films. Accordingly, charges accumulating on surface of the photo-alignment films cannot be discharged. The accumulated charges thus form a built-in electric field in the display panel, which displays an opposite direction of the electric field that drives liquid crystal molecules in the panel in a normal way, thus easily resulting in issues such as ghost images, image flicker and drift that influence the image display quality.

Accordingly, an improved display panel, an improved photo-alignment film, and an improved fabrication method thereof are required. The disclosed display panel, photo-alignment films and fabrication method thereof are directed to solve one or more problems set forth above and other problems.

The above information disclosed in this background section is only for enhancement of understanding of the background of the invention and therefore it may contain information that does not form the prior art that is already known to a person of ordinary skill in the art.

### BRIEF SUMMARY OF THE DISCLOSURE

One aspect of the present disclosure provides a display panel. The display panel includes a first substrate, a second substrate disposed opposite to the first substrate, and a liquid crystal layer sandwiched between the first substrate and the second substrate. The first substrate includes a first photo-alignment film comprising a first photo-alignment layer and a first conductive layer that are stacked. The first photo-alignment layer is disposed close to the liquid crystal layer. The first conductive layer is electrically connected to a conductive structure in the display panel, and a resistivity of the first conductive layer is smaller than 10¹⁴ Ω·cm. The second substrate includes a second photo-alignment film disposed close to the liquid crystal layer.

Another aspect of the present disclosure provides a photo-alignment film. The photo-alignment film includes a conductive layer and a photo-alignment layer. The conductive layer and the photo-alignment layer are stacked. The photo-alignment layer has an alignment function, and a resistivity of the conductive layer is smaller than 10¹⁴ Ω·cm.

Another aspect of the present disclosure provides a fabrication method of a photo-alignment film including forming a photo-alignment material film layer, and pre-curing the photo-alignment material film layer such that the photo-alignment material film layer is delaminated. Linearly polarized light is used to irradiate a delaminated photo-alignment material film layer to produce the photo-alignment material film layer having an alignment function. Further, the delaminated photo-alignment material film layer is treated with primary curing, such that a photo-alignment layer and a conductive layer that are stacked are formed. A resistivity of the conductive layer is smaller than 10¹⁴ Ω·cm.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates an exemplary display panel consistent with disclosed embodiments;

FIG. 2 illustrates another exemplary display panel consistent with disclosed embodiments;

FIG. 3 illustrates an exemplary test diagram of flicker and drift of a display panel corresponding to first photo-alignment films with different resistances consistent with disclosed embodiments;

FIG. 4 illustrates another exemplary display panel consistent with disclosed embodiments;

FIG. 5 illustrates another exemplary display panel consistent with disclosed embodiments; and

FIG. 6 illustrates an exemplary flow chart of a fabrication method for a type of photo-alignment films consistent with disclosed embodiments.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention. Further, in the present disclosure, the disclosed embodiments and the features of the disclosed embodiments may be combined or separated under conditions without conflicts.

In existing photo-alignment techniques, single-layered polyimide films employed to align liquid crystal molecules may be difficult to be fabricated into low-resistance films. Accordingly, to avoid residual images caused by the residual direct current, photo-alignment polyimide films may be designed to have a structure showing two separated layers. An upper layer may be a photo-alignment layer, and a lower layer may be a conductive layer made of polyimide. By modifying the structure and constituent of the conductive layer, the resistance of the photo-alignment polyimide film may be adjusted.

However, existing alignment films compatible for a rubbing process may often include rubbed polyimide films with high resistance. When the rubbed polyimide films with high resistance are applied to control nematic liquid crystals, issues such as image flicker and drift may occur, thus affecting the image display quality. Further, when photo-alignment polyimide films are used to replace existing rubbed polyimide films to control nematic liquid crystals, if the resistance of the photo-alignment polyimide film is close to that of the rubbed polyimide film, image flicker and drift may also occur.

The present disclosure provides an improved display panel, an improved photo-alignment film, and an improved fabrication method thereof. The disclosed structure and constituent of the lower layer in the photo-alignment film (i.e., conductive layer) may be modified to vary the film resistance within an appropriate range, thus overcoming the issues of image flicker and drift.

In various embodiments of the present disclosure, a display panel may include a color film substrate, an array substrate arranged opposite to the color film substrate, and a liquid crystal layer sandwiched between the color film substrate and the array substrate. The array substrate may include a first photo-alignment film, the first photo-alignment film may include a first photo-alignment layer and a first conductive layer that are stacked, and the first photo-alignment layer may be disposed close to the liquid crystal layer. The color film substrate may include a second photo-alignment film, and the second photo-alignment film may be disposed close to the liquid crystal layer.

Because an existence of impurity ions may be unavoidable in the liquid crystal layer and the first photo-alignment film, under effects of an electric field that drives the liquid crystal molecules in the liquid crystal layer of a display panel to rotate, the impurity ions may form charges accumulated on the first photo-alignment film. Further, another electric field with an opposite direction of the electric field may be formed to drive rotation of the liquid crystal molecules, thus affecting display effects of the display panel.

In the present disclosure, a resistivity of the first conductive layer may be smaller than 10¹⁴ Ω·cm, and the first conductive layer may be electrically connected to a conductive structure in the display panel. Thus, the charges accumulated on the first photo-alignment film may be guided into the conductive structure in the display panel via the first conductive layer with a low resistance and, later, guided out via the conductive structure. The conductive structure in the display panel may be any appropriate metallic wiring in the display panel, or may be a circuit element in the display panel, which is not limited by the present disclosure as long as the conductive structure realizes a function that guides out the accumulated charges.

Optionally, the conductive structure in the display panel may be one or a plurality of structures selected from a pixel electrode layer, a common electrode layer, data lines, scanning lines, a metallic shell, a static electricity prevention circuit, or a grounding wire. Optionally, the conductive structure in the display panels may need no extra fabrication. That is, by electrically connecting an original conductive structure in the display panel to the first conductive layer, the charges accumulated on the first photo-alignment film may be removed.

More specifically, the technical solution of the present disclosure may be illustrated in the followings with reference to the accompanying drawings. For those skilled in the art, other embodiments may be obtained based on the embodiments of the present disclosure, all of which fall within the scope of the present disclosure.

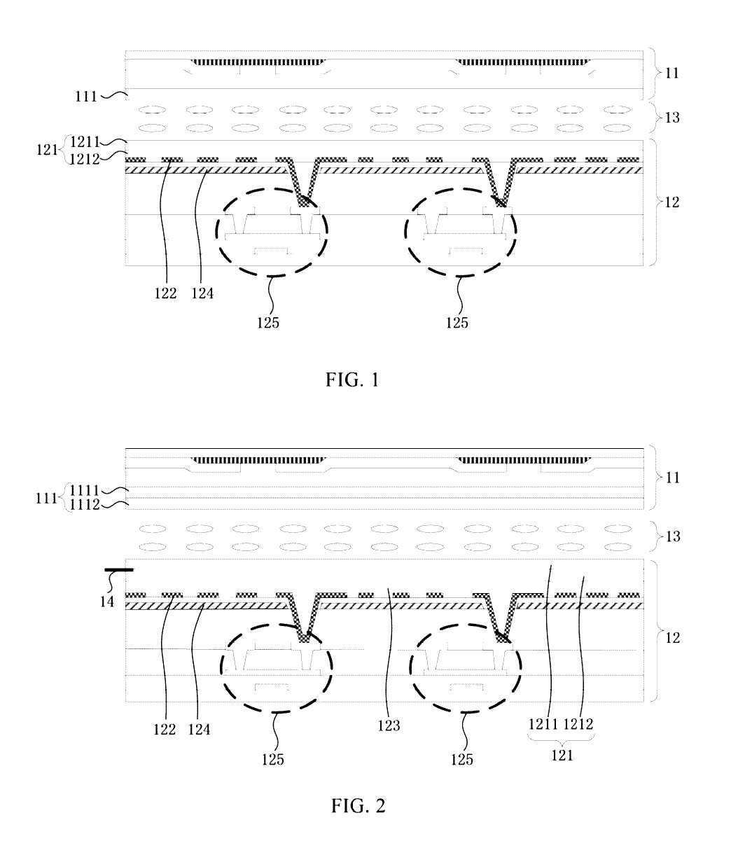

FIG. 1 illustrates an exemplary display panel consistent with disclosed embodiments. As shown in FIG. 1, the disclosed display panel may include a color film substrate 11, an array substrate 12 arranged opposite to the color film substrate 11, and a liquid crystal layer 13 sandwiched between the color film substrate 11 and the array substrate 12. The array substrate 12 may include a first photo-alignment film 121. The first photo-alignment film may include a first photo-alignment layer 1211 and a first conductive layer 1212 that are stacked, and the first photo-alignment layer 1211 may be disposed close to the liquid crystal layer 13. The color film substrate 11 may include a second photo-alignment film 111, and the second photo-alignment film 111 may be disposed close to the liquid crystal layer 13. The array substrate 12 may include a pixel electrode layer 122, and the first conductive layer 1212 may be connected to the pixel electrode layer 122. A resistivity of the first conductive layer may be smaller than 10¹⁴ Ω·cm.

In one embodiment, a non-contact photo-alignment method may be applied to provide a pretilt angle for liquid crystal molecules in the liquid crystal layer 13. For example, linearly polarized ultra-violet light may be used to irradiate the first photo-alignment film 121 and the second photo-alignment film 111 and, thus, the first photo-alignment film 121 and the second photo-alignment film 111 may have an alignment ability. In the photo-alignment method, to avoid surface pollution of the substrate, parameters of the liquid crystal molecules, such as pretilt angle and directional intensity, may be controlled based on the angle and irradiation duration of the incident light.

Because the photo-alignment film 111 may contain molecules having an alignment function, but molecules having an alignment function may often belong to high-resistant materials, in one embodiment, the first photo-alignment film 121 may be configured with a double-layered structure to avoid charges being accumulated on surface of high-resistant photo-alignment films. A photo-alignment material that forms the first photo-alignment film 121 with a double layered structure may be a liquid having a certain viscosity.

After the photo-alignment material is coated to form a photo-alignment material film layer, the photo-alignment material film layer may need to be pre-cured to remove solvents in the photo-alignment material, and delaminate the photo-alignment material film layer, thus preventing the liquid photo-alignment material from flowing towards surroundings. During pre-curing treatment, molecules having an alignment function may move up towards a top of the photo-alignment material film layer, and molecules having a conductive function may move down towards a bottom of the photo-alignment material film layer, thus forming a double-layered structure. The linearly polarized ultra-violet light may be used to irradiate a delaminated photo-alignment material film layer to produce the photo-alignment material film layer having an alignment function. The delaminated photo-alignment material film layer may be cured and molded, thus forming stacked first photo-alignment layer 1211 and first conductive layer 1212.

Specifically, the first photo-alignment layer 1211 may have an alignment function and may be in contact with the liquid crystal layer 13, thus enabling liquid crystal molecules in the liquid crystal layer 13 to have a preset pretilt angle. The first conductive layer 1212 may not be in contact with the liquid crystal layer 13 and, thus, may not have an alignment function. Further, the first conductive layer 1212 configured in the present disclosure may have a resistivity smaller than 10¹⁴ Ω·cm, and possess a conductive function.

Accordingly, the first conductive layer 1212 may timely transfer accumulated charges to the pixel electrode layer 122. An external circuit may provide a data voltage to the pixel electrode layer 122, such that electrons or holes may be timely supplemented. Accumulated charges transferred from the first conductive layer 1212 may offset the electrons or holes, such that accumulation of charges may be timely avoided. Further, issues such as ghost images, image flicker and drift due to accumulation of charges on the first photo-alignment film 121 may also be avoided.

In one embodiment, the first conductive layer 1212 may directly contact the pixel electrode layer 122. Other configurations may also be used as long as the first conductive layer 1212 is electrically connected to the pixel electrode layer 122, and the first conductive layer 1212 transfers charges accumulated on surface of the first photo-alignment film 121 to the pixel electrode layer 122. For example, the conductive structure in FIG. 1 may be configured to be pixel electrodes.

In other embodiments, the first conductive layer 1212 may be connected to at least one structure selected from a common electrode layer, data lines, scanning lines, a metallic shell, a static electricity prevention circuit, or a grounding wire. Specifically, the first conductive layer 1212 may be electrically connected to the common electrode layer, the data line, the scanning line, the metallic shell, the static electricity prevention circuit or the grounding wire via punching and pouring silver paste or depositing metallic wires.

FIG. 2 illustrates another exemplary display panel consistent with disclosed embodiments. Different from FIG. 1, as shown in FIG. 2, the first conductive layer 1212 may be connected to a grounding wire 14 in the display panel. The grounding wire 14 in the display panel may be regarded as the conductive structure that guides out the accumulated charges. Because the existence of impurity ions may not be avoided in the liquid crystal layer 13 and the first photo-alignment film 121, under effects of an electric field that drives liquid crystals, the impurity ions may form accumulated charges on surface of the first photo-alignment film 121. Because the first conductive layer 1212 may be electrically connected to the grounding wire 14 in the display panel, the first conductive layer 1212 may timely remove accumulated charges, thus avoiding issues such as ghost images, image flicker and drift caused by accumulation of charges on the first photo-alignment film 121.

Further, referring to FIG. 2, optionally, the second photo-alignment film 111 may also include a second photo-alignment layer 1111 and a second conductive layer 1112 that are stacked to ensure symmetry between the second photo-alignment film 111 on one side of the color film substrate 11 and the first photo-alignment film 121 on one side of the array substrate 12.

Optionally, referring to FIG. 2, an insulation layer 123 may be sandwiched between the pixel electrode layer 122 and the first conductive layer 1212 to ensure stability of signals on the pixel electrode layer 122.

The liquid crystal molecules in the liquid crystal layer 13 may be positive liquid crystals or negative liquid crystals. Further, any appropriate resistivity of the first photo-alignment layer 1211 may be used as long as the first photo-alignment layer 1211 shows adequate alignment ability. For example, the resistivity of the first photo-alignment layer 1211 may be configured to be larger than 10¹⁵ Ω·cm.

In some embodiments, the resistivity of the first photo-alignment film 121 may be larger than or equal to a resistivity of the liquid crystal layer 13, and smaller than 10 times the resistivity of the liquid crystal layer 13. In cooperation with the liquid crystal layer 13 in the display panel, the resistivity of the first photo-alignment film 121 may be configured within the above range, which may significantly alleviate the flicker and drift phenomenon of the display panel. FIG. 3 illustrates an exemplary test diagram showing flicker amplitudes of display panels corresponding to first photo-alignment films with different resistances consistent with disclosed embodiments.

As shown in FIG. 3, a y-axis indicates contrast value of display brightness, and an x-axis indicates time. The contrast value of the display brightness may refer to a ratio between measured brightness and reference brightness of the display panel. Table 1 lists resistivity values of seven first photo-alignment films A-G in FIG. 3, and resistivity values of corresponding liquid crystal layers.

TABLE 1

| | First photo- | First photo- | First photo- | First photo- | First photo- | First photo- | First photo- | Liquid |
|---|---|---|---|---|---|---|---|---|
| | alignment | alignment | alignment | alignment | alignment | alignment | alignment | crystal |
| | film A | film B | film C | film D | film E | film F | film G | layer |
| Resistivity | 3.8 × 10¹⁵ | 1.5 × 10¹⁴ | 7.8 × 10¹³ | 4.9 × 10¹³ | 4.0 × 10¹³ | 3.1 × 10¹³ | 1.0 × 10¹³ | 3.1 × 10¹³ |
| (Ω · cm) | | | | | | | | |

As shown in Table 1, resistivity of the first photo-alignment film A may be 3.8×10¹⁵ Ω·cm, resistivity of the first photo-alignment film B may be 1.5×10¹⁴ Ω·cm, resistivity of the first photo-alignment film C may be 7.8×10¹³ Ω·cm, resistivity of the first photo-alignment film D may be 4.9×10¹³ Ω·cm, resistivity of the first photo-alignment film E may be 4.0×10¹³ Ω·cm, resistivity of the first photo-alignment film F may be 3.1×10¹³ Ω·cm, resistivity of the first photo-alignment film G may be 1.0×10¹³ Ω·cm, and resistivity of the corresponding liquid crystal layer may be 3.1×10¹³ Ω·cm.

Referring to FIG. 3 and Table 1, the first photo-alignment films A and G may show a relatively significant change in the contrast value of display brightness when the display time varies. Accordingly, flicker and drift of the display panels corresponding to the first photo-alignment films A and G may be relatively large, while flicker and drift of the display panels corresponding to the first photo-alignment films B-F may be relatively small. The resistivity of the first photo-alignment films B-F may all be larger than or equal to that of the liquid crystal layer 13, and smaller than 10 times the resistivity of the liquid crystal layer 13.

Accordingly, optionally, a thickness of the first photo-alignment film 121 and/or a thickness of the second photo-alignment film 111 may be larger than 80 nm. On one hand, insufficient alignment due to too small thickness of the first photo-alignment film 121 and/or too small thickness of the second photo-alignment film 111 may thus be avoided, on the other hand, a condition where accumulated charges cannot be removed caused by a too large resistance of a film layer due to a too large thickness of the first photo-alignment film 121 and/or a too large thickness of the second photo-alignment film 111 may be avoided.

Optionally, the first photo-alignment layer 1211 may include polyimide with a general molecular formula of

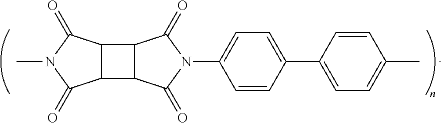

The first conductive layer 1212 may include polyimide with a general molecular formula of

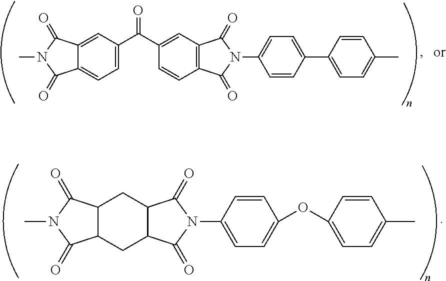

Based on the above-described embodiments, the resistivity of the second conductive layer 1112 may be configured to be smaller than 10¹⁴ Ω·cm. The resistivity of the second photo-alignment layer 1111 may be larger than 10¹⁵ Ω·cm. The resistivity of the second photo-alignment film 111 may be larger than or equal to the resistivity of the liquid crystal layer 13, and smaller than 10 times the resistivity of the liquid crystal layer 13. The second photo-alignment layer 1111 may include polyimide with a general molecular formula of

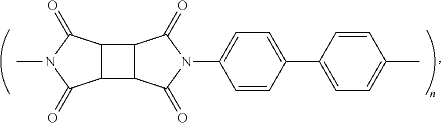

and the second conductive layer 1112 may include polyimide with a general molecular formula of

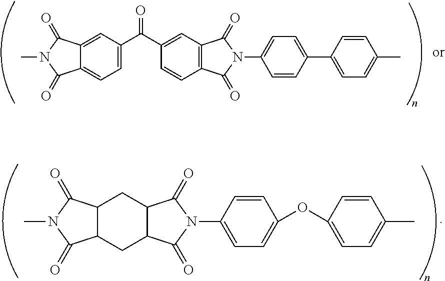

Further, when the conductive structure in the display panel is the common electrode layer, the data line, the scanning line, the metallic shell, or the static electricity prevention circuit, etc., those skilled in the art may obtain a configuration where the first conductive layer is electrically connected to the conductive structure in the display panel selected from the common electrode layer, the data line, the scanning line, the metallic shell, and the static electricity prevention circuit, etc.

The present disclosure may be applied in twisted nematic (TN) liquid crystal display panels, or wide viewing angle liquid crystal display panels. FIG. 1 and FIG. 2 may illustrate the present disclosure based on wide viewing angle liquid crystal display panels.

The wide viewing angle liquid crystal panels may include in-plane switching (IPS) or fringe field switching (FFS) liquid crystal display panels. Different from IPS or FFS liquid crystal display panels, TN liquid crystal display panels may have a common electrode layer disposed on one side of the color film substrate, and a pixel electrode layer disposed on one side of the array substrate. A perpendicular electric field may form between the pixel electrode layer and the common electrode layer that drives the liquid crystal molecules to rotate.

In IPS or FFS liquid crystal display panels, the common electrode layer and the pixel electrode layer may both form on one side of the array substrate. A horizontal electric field may form between the common electrode layer and the pixel electrode layer that is parallel to the plane of the common electrode layer or the plane of the pixel electrode layer. The liquid crystal molecules may be driven by the horizontal electric field to twist while staying in parallel with the plane of the common electrode layer or the plane of the pixel electrode layer.

Referring to FIG. 1 and FIG. 2, a common electrode layer 124 and the pixel electrode layer 122 in the array substrate 12 may be mutually isolated, and may be both disposed on one side of the first conductive layer 1212 facing away the first photo-alignment layer 1211. FIG. 1 and FIG. 2 both show FFS liquid crystal display panels, the common electrode layer 124 and the pixel electrode layer 122 may be disposed on different layers, and the pixel electrode layer 122 may be configured with a plurality of slits.

In other embodiments, FFS liquid crystal display panels may configure the common electrode layer and the pixel electrode layer to be disposed on different layers, the common electrode layer may be configured with a plurality of slits, or the common electrode layer and the pixel electrode layer may both be configured with a plurality of slits. The present disclosure does not limit the common electrode layer 124 or the pixel electrode layer 122 to be an upper layer or a lower layer. For example, in FIG. 1 and FIG. 2, the pixel electrode layer 122 may be disposed on top of the common electrode layer 124. If the common electrode layer 124 is disposed on top of the pixel electrode layer 122, to avoid the electric field being shielded by electrode layers, preferentially, the upper electrode layer (e.g., the common electrode layer 124) may be configured with a plurality of slits.

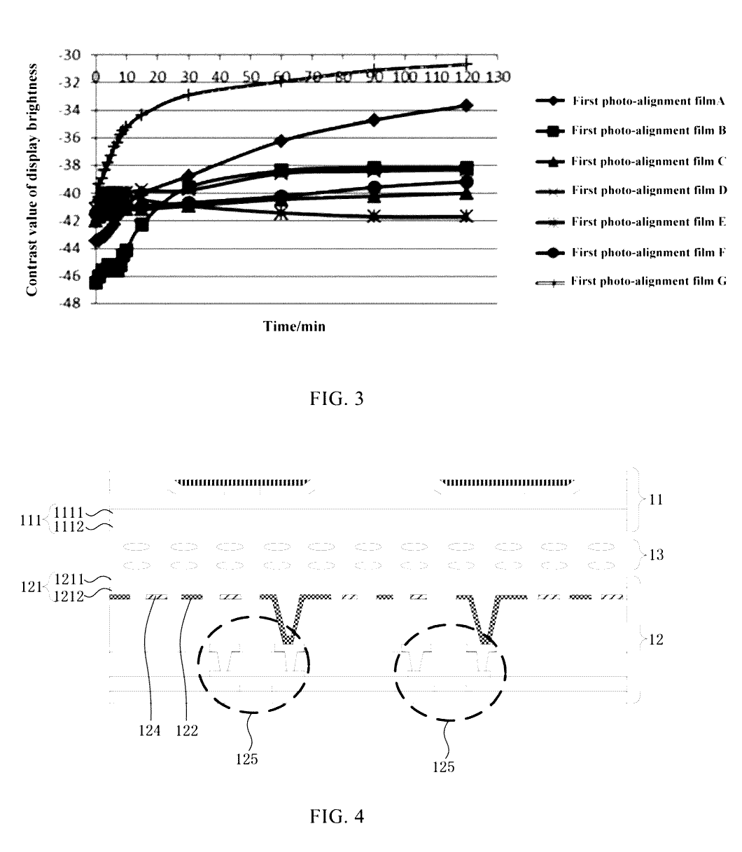

FIG. 4 illustrates another exemplary display panel consistent with disclosed embodiments. As shown in FIG. 4, different from FIG. 1 and FIG. 2, the display panel provided in FIG. 4 may be an IPS liquid crystal display panel. In the IPS liquid crystal display panel, the common electrode layer 124 may be disposed alternatively with the pixel electrode layer 122 on a same layer. The first conductive layer 1212 may be simultaneously and electrically connected to the pixel electrode layer 122 and the common electrode layer 124, and the charges accumulated on the first photo-alignment film 121 may dissipate via the pixel electrode layer 122 and the common electrode layer 124.

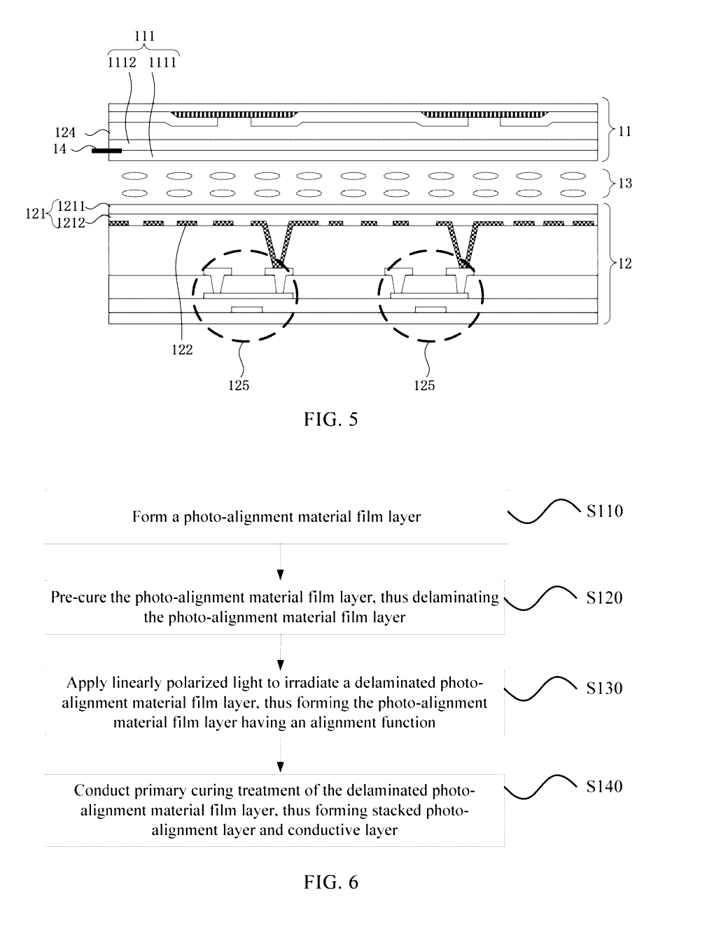

FIG. 5 illustrates another exemplary display panel consistent with disclosed embodiments. As shown in FIG. 5, the display panel may be a TN liquid crystal display panel. The color film substrate 11 may include the common electrode layer 124, and the array substrate 12 may include the pixel electrode layer 122. Because the common electrode layer 124 and the pixel electrode layer 122 may be disposed on two sides of the liquid crystal layer, respectively, the electric field generated by the common electrode layer 124 and the pixel electrode layer 122 that drives liquid crystal molecules may run across the entire liquid crystal layer 13, the first photo-alignment film 121 and the second photo-alignment film 111. Accordingly, under effects of the electric field that drives liquid crystal molecules, charges may easily accumulate on the second photo-alignment film 111.

Thus, the second photo-alignment film 111 in the color film substrate 11 of the TN liquid crystal display panel may be configured to be a double-layered structure that includes the second photo-alignment layer 1111 and the second conductive layer 1112. The conductive structures that the first conductive layer 1212 and the second conductive layer 1112 connect to may be the same or may be different. For example, in FIG. 5, the first conductive layer 1212 may connect to the pixel electrode layer 122, and the second conductive layer 1112 may connect to the grounding wire 14. In other embodiments, the first conductive layer 1212 and the second conductive layer 1112 may connect to the same conductive structure (e.g., the grounding wire 14).

In certain other embodiments, the second conductive layer 1112 may connect to the common electrode layer 124, the pixel electrode layer 122, the data line (not shown), the scanning line (not shown), the metallic shell (not shown), or the static electricity prevention circuit (not shown) via perforated silver paste. By electrically connecting the second conductive layer 1112 on one side of the color film substrate 11 to the conductive structure in the display panel, the present disclosure may timely remove charges accumulated on the second photo-alignment film 111, thus further alleviating the phenomenon of ghost images, image flicker and drift in the display panel.

The first conductive layer 1212 and the second conductive layer 1112 may both electrically connected to a plurality of conductive structures. For example, in FIG. 5, the second conductive layer 1112 may be simultaneously and electrically connected to the common electrode layer 124 and the grounding wire 14.

Further, optionally, referring to FIG. 1-FIG. 5, the array substrate may include a plurality of thin film transistors 125. An active layer 1251 in the thin film transistor 125 may be made of a low-temperature poly-silicon material.

The present disclosure also provides a photo-alignment film, and the photo-alignment film may include stacked photo-alignment layer and conductive layer. The resistivity of the conductive layer may be smaller than 10¹⁴ Ω·cm. The photo-alignment film provided by the present disclosure may be applied in the display panel described by any above embodiment.

Optionally, the resistivity of the photo-alignment layer may be larger than 10¹⁵ Ω·cm.

Optionally, the photo-alignment layer may include polyimide with a general molecular formula of

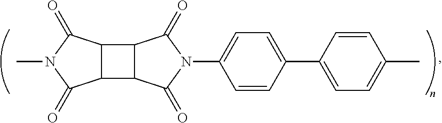

the conductive layer may include polyimide with a general molecular formula of

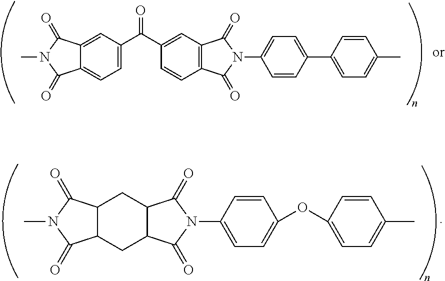

The present disclosure also provides a fabrication method for photo-alignment films. FIG. 6 illustrates an exemplary flow chart of the fabrication method for the photo-alignment film consistent with disclosed embodiments.

As shown in FIG. 6, the fabrication method may include forming a photo-alignment film layer (Step 110). For example, the photo-alignment material film layer may form on a substrate by method of spin or inkjet printing. The photo-alignment material film layer may contain molecules having an alignment function, and when linearly polarized ultra-violet light irradiate the photo-alignment material film layer, the molecules may have an alignment ability.

The fabrication method may also include pre-curing the photo-alignment material film layer to delaminate the photo-alignment material film layer (Step 120). The photo-alignment material may be liquid having a certain viscosity. After the photo-alignment material is coated to form the photo-alignment material film layer, the photo-alignment material film layer may need to be pre-cured to remove solvents in the photo-alignment material and delaminate the photo-alignment material film layer, thus preventing the liquid photo-alignment material from flowing towards surroundings. During pre-curing treatment, molecules having an alignment function may move up towards a top of the photo-alignment material film layer, and molecules having a conductive function may move down towards a bottom of the photo-alignment material film layer, thus forming a double-layered structure.

The fabrication method may also include using linearly polarized light to irradiate the delaminated photo-alignment material film layer, thus forming the photo-alignment material film layer having an alignment function (Step 130). Further, the fabrication method may include curing the delaminated photo-alignment material film layer to form stacked photo-alignment layer and conductive layer.

The delaminated photo-alignment material film layer may be cured and molded, thus forming stacked photo-alignment layer and conductive layer. In particular, the resistivity of the conductive layer may be smaller than 10¹⁴ Ω·cm.

The fabrication method of the photo-alignment film provided by the present disclosure may produce photo-alignment films with a delaminated structure, where an upper layer of the delaminated structure may be a photo-alignment layer. When fabricating display panels, the photo-alignment layer may be in contact with the liquid crystal layer, thus providing a pretilt angle for liquid crystal molecules in the liquid crystal layer. A lower layer of the delaminated structure may be a conductive layer, and the resistivity may be smaller than 10¹⁴ Ω·cm.

Because the conductive layer in the photo-alignment film having stacked photo-alignment layer and conductive layer may have a much smaller resistivity than traditional high-resistant photo-alignment films, charges accumulated on the photo-alignment film may be timely guided out. For example, the charges may be transferred to the pixel electrode layer in the display panel, the common electrode layer, or the grounding wire in the display panel, thus removing accumulated charges and avoiding accumulation of charges on the photo-alignment film that result in issues like ghost images, image flicker and drift.

Optionally, the resistivity of the photo-alignment layer may be larger than 10¹⁵ Ω·cm. Further, the resistivity of the photo-alignment layer and the resistivity of the conductive layer may be adjusted by configuring parameters of the pre-curing treatment. For example, pre-curing temperature may be higher than or equal to 110° C., and pre-curing duration may be longer than or equal to 80 s.

The primary curing temperature may be higher than or equal to 230° C., and primary curing duration may be longer than or equal to 15 min.

Optionally, the photo-alignment material film layer may include polyimide, polyamide acid, and solvents. For example, the photo-alignment layer may include polyimide with a general molecular formula of

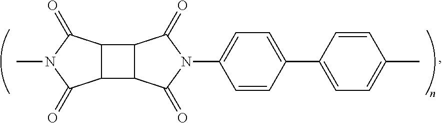

and the conductive layer may include polyimide with a general molecular formula of

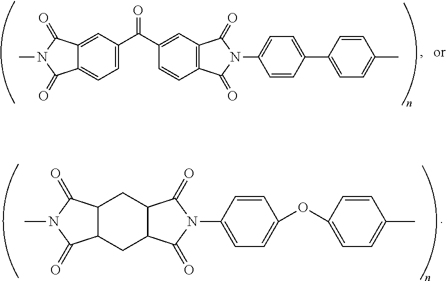

The disclosed embodiments are exemplary only and do not limit the scope of this disclosure. Various combinations, alternations, modifications, or equivalents to the technical solutions of the disclosed embodiments can be obvious to those skilled in the art and can be included in this disclosure. Without departing from the spirit and scope of this invention, such other modifications, equivalents, or improvements to the disclosed embodiments are intended to be encompassed within the scope of the present disclosure.

What is claimed is:

1. A display panel, comprising:
a first substrate;
a second substrate disposed opposite to the first substrate; and
a liquid crystal layer sandwiched between the first substrate and the second substrate;
wherein the first substrate includes a first photo-alignment film comprising a first photo-alignment layer and a first conductive layer that are stacked, the first photo-alignment layer is disposed close to the liquid crystal layer, the first conductive layer is electrically connected to a conductive structure in the display panel, a resistivity of the first conductive layer is smaller than 10¹⁴ Ω·cm, and
the second substrate includes a second photo-alignment film disposed close to the liquid crystal layer.

2. The display panel according to claim 1, wherein:
the first substrate is an array substrate; and
the second substrate is a color film substrate.

3. The display panel according to claim 1, wherein a resistivity of the first photo-alignment layer is larger than 10¹⁵ Ω·cm.

4. The display panel according to claim 1, wherein:
a resistivity of the first photo-alignment film is larger than or equal to a resistivity of the liquid crystal layer, and is smaller than 10 times the resistivity of the liquid crystal layer.

5. The display panel according to claim 1, wherein:
at least one of a thickness of the first photo-alignment film and a thickness of the second photo-alignment film is larger than 80 nm.

6. The display panel according to claim 1, wherein:
the first photo-alignment layer comprises polyimide with a general molecular formula of 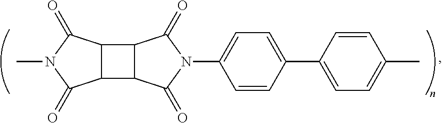
and
the first conductive layer comprises polyimide with a general molecular formula of

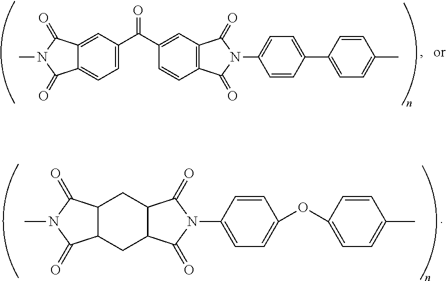

7. The display panel according to claim 1, wherein:
the second photo-alignment film includes a second photo-alignment layer and a second conductive layer that are stacked.

8. The display panel according to claim 7, wherein:
a resistivity of the second photo-alignment film is larger than or equal to the resistivity of the liquid crystal layer, and is smaller than 10 times the resistivity of the liquid crystal layer.

9. The display panel according to claim 2, wherein:
the color film substrate comprises a common electrode layer.

10. The display panel according to claim 9, wherein:
the second photo-alignment film comprises stacked second photo-alignment layer and second conductive layer, and the second conductive layer is electrically connected to a wiring structure in the display panel.

11. The display panel according to claim 1, wherein:
the conductive structure is at least one of a pixel electrode layer, the common electrode layer, data lines, scanning lines, a metallic shell, a static electricity prevention circuit, and a grounding wire.

12. The display panel according to claim 2, wherein:
the array substrate includes the pixel electrode layer and the common electrode layer, the common electrode layer and the pixel electrode layer are mutually insulated and are both disposed on one side of the first conductive layer facing away the first photo-alignment layer.

13. The display panel according to claim 12, wherein:
the common electrode layer and the pixel electrode layer are disposed alternatively on a same layer; or
the common electrode layer and the pixel electrode layer are disposed on different layers, and at least one of the common electrode layer and the pixel electrode layer are configured with a plurality of slits.

14. The display panel according to claim 2, wherein:
the array substrate includes a plurality of thin film transistors, and an active layer in each thin film transistor is made of a low-temperature poly-silicone material.

15. A photo-alignment film, comprising:
a conductive layer and a photo-alignment layer,
wherein the conductive layer and the photo-alignment layer are stacked, the photo-alignment layer has an alignment function, and a resistivity of the conductive layer is smaller than 10¹⁴ Ω·cm.

16. The photo-alignment film according to claim 15, wherein:
the photo-alignment layer comprises polyimide with a general molecular formula of 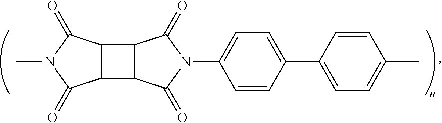
and
the conductive layer comprises polyimide with a general molecular formula of

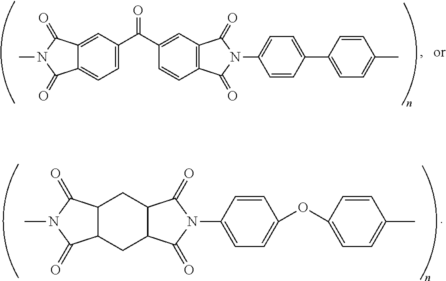

17. A fabrication method of a photo-alignment film, comprising:
forming a photo-alignment material film layer;
pre-curing the photo-alignment material film layer, such that the photo-alignment material film layer is delaminated;
using linearly polarized light to irradiate a delaminated photo-alignment material film layer to produce the photo-alignment material film layer having an alignment function; and
conducting primary curing treatment of the delaminated photo-alignment material film layer, thus forming stacked photo-alignment layer and conductive layer, where a resistivity of the conductive layer is smaller than 10¹⁴ Ω·cm.

18. The method according to claim 17, wherein:
a temperature of pre-curing treatment is higher than or equal to 110° C., and duration of the pre-curing treatment is longer than or equal to 80 s; and
a temperature of primary curing treatment is higher than or equal to 230° C., and duration of the primary treatment is longer than or equal to 15 min.

19. The method according to claim 17, wherein:
the photo-alignment material film layer comprises polyimide, polyamide acid, and solvents.

20. The method according to claim 17, wherein:
the photo-alignment layer comprises polyimide with a general molecular formula of 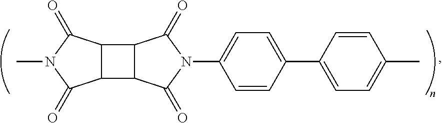
and
the conductive layer comprises polyimide with a general molecular formula of [chemical structure]
